(19) United States
(12) Patent Application Publication
(10) Pub. No.: US 2005/0165909 A1
(43) Pub. Date: Jul. 28, 2005

(54) Data processing system and method for permitting a server to remotely access asset information of a mobile client

(76) Inventors: Daryl Carvis Cromer, Apex, NC (US); Howard Jeffrey Locker, Cary, NC (US); Randall Scott Springfield, Chapel Hill, NC (US)

Correspondence Address: LALLY & LALLY, L.L.P., P. O. BOX 684749, AUSTIN, TX, 78768-4749, US

(21) Appl. No.: 10/742,151

(22) Filed: Dec. 19, 2003

(51) Int. Cl. G06F 15/16

(52) U.S. Cl. 709/219

(57) ABSTRACT

A data processing network configuration includes a server and an access point wired to a network and a mobile system wirelessly connected to the access point. The access point receives and stores a request to retrieve information from the mobile system. The mobile system, when in a powered down state, powers its wireless network adapter periodically to poll the access point to discover the stored request for information. The mobile system responds to discovery of the stored request by retrieving the requested information from nonvolatile storage of the mobile system and transmitting the requested information via the wireless network adapter while otherwise remaining powered down. The information request may be a system management request and the request packet may include a Media Access Control (MAC) address repeated multiple times. The access point stores pending requests in a table having an entry for each associated mobile system.

### BACKGROUND

1. Field of the Present Invention The present invention relates in general to data processing networks and, in particular, to data processing networks that employ remote management to gather asset information from clients on the network.

2. History of Related Art

Microprocessor-based computer systems have attained widespread use for providing computer power to business, educational institutions, government, and consumers. A microprocessor based computer may be defined as any desktop, floor standing, or portable system that includes a general purpose microprocessor central processing unit (CPU) and associated volatile and non-volatile memory, including random access memory (RAM) and basic input/output system read only memory (BIOS ROM), and input/output (I/O) devices including a system monitor, a keyboard, a CD-ROM drive, a fixed disk storage drive (also known as a “hard drive”), a pointing device such as a mouse, and, in the context of a networked computer, a network interface adapter or network interface card (NIC).

With computers being increasingly connected into networks to allow transfers of data among computers to occur, more operations such as maintenance, updating of applications, and data collections are occurring over the network. Computer networks are also becoming essential to their users. It is desirable to minimize loss of productivity by increasing availability of network resources.

Remote management of client computer systems is becoming a part of both large and medium networks. Remote management provides tremendous cost of ownership advantages and provides better quality of service for a client. One example of a remote management application is the collection or asset or inventory information.

Known systems exist for remotely collecting asset information from client computer systems. The asset information collected by these systems includes information indicative of the client's hardware and software components. For example, serial numbers, part numbers, and/or other information that identifies a client's memory, hard drives, operating system, software, and other components may be stored within the particular client.

A Management Information Format (MIF) file is typically utilized to store asset information. A MIF file is an industry standard file defining locations and formats for storing asset information. MIF is fully described in the Desktop Management Interface (DMI) Specification v2.0s from the Desktop Management Task Force (www.dmtf.org/standards/dmi/spec).

One known method utilizes a DMI command to permit a server to retrieve desired asset information from a client. In this method, the server transmits a DMI request to a particular client to obtain information stored in the client's MIF file. Cromer et al., described a method of acquiring asset information when the client is powered down via a “constantly-powered” NIC. Data Processing System and Method for Permitting a Server to Remotely Access a Powered-Off Client Computer System's Asset Information (U.S. Pat. No. 6,381,636 issued Apr. 30, 2002).

With the advent of wireless LAN's, encountering mobile (i.e., wireless) systems that do not have a constantly powered NIC is becoming increasingly common. Because conserving battery life is critical in wireless environments, it is not feasible to supply constant power to the NIC. A need exists for a data processing system and method that permits a server to remotely access a wireless client computer system's asset information.

### SUMMARY OF THE INVENTION

The identified need is addressed with a data processing network configuration that includes a server and an access point wired to a network and a mobile system wirelessly connected to the access point. The access point receives and stores a request to retrieve information from the mobile system. The mobile system, when in a powered down state, powers its wireless network adapter periodically to poll the access point to discover the stored request for information. The mobile system responds to discovery of the stored request by retrieving the requested information from nonvolatile storage of the mobile system and transmitting the requested information via the wireless network adapter while otherwise remaining powered down. The information request may be a system management request and the request packet may include a Media Access Control (MAC) address repeated multiple times. The access point is stores pending requests in a table having an entry for each associated mobile system.

### BRIEF DESCRIPTION OF THE DRAWINGS

Other objects and advantages of the invention will become apparent upon reading the following detailed description and upon reference to the accompanying drawings in which:

FIG. 1 is a block diagram of a data processing network according to one embodiment of the present invention;

FIG. 2 is a block diagram of a mobile data processing system according to one embodiment of the invention;

FIG. 3 is a block diagram of selected elements of a access point according to one embodiment of the present invention;

FIG. 4 is a conceptual depiction of an information table of the access point of FIG. 3;

FIG. 5 is a flow diagram of a method of remotely retrieving information from a mobile data processing system according to one embodiment of the present invention.

While the invention is susceptible to various modifications and alternative forms, specific embodiments thereof are shown by way of example in the drawings and will herein be described in detail. It should be understood, however, that the drawings and detailed description presented herein are not intended to limit the invention to the particular embodiment disclosed, but on the contrary, the intention is to cover all modifications, equivalents, and alternatives falling within the spirit and scope of the present invention as defined by the appended claims.

### DETAILED DESCRIPTION OF THE INVENTION

The present invention may be described generally as a method and implementation for remotely accessing data stored in a mobile data processing system when the mobile system is powered down. The specific embodiment described below refers to asset information stored on the wireless system, but other implementations may retrieve other data or information from the system in a similar manner.

The mobile data processing system includes a central processing system (CPU), system memory, and I/O devices including a wireless network adapter or NIC (for Network Interface Card). The wireless adapter, like other elements of the mobile system, is designed to conserve energy by powering down when not in use. Power conservation is a critical consideration in the design of mobile systems where battery life (i.e., the amount to time the system can remain operational when disconnected from a source of AC power) is the most significant limitation of the system for many users.

Because the wireless NIC in a mobile system is not continuously powered, existing methods for remotely retrieving data, such as asset information, from a powered-down system, which typically assume or require the presence of a continuously powered NIC, are not feasible. The present invention addresses this issue by describing a method and system that uses the facilities of a continuously powered wireless access point (AP) through which the mobile system connects to a network.

A server desiring to retrieve asset information from a powered-down mobile system, sends a request to the system over the network using, for example, existing DMI and MIF protocols. The asset information request is ultimately forwarded to the AP with which the mobile system is associated. The AP stores the request itself or information otherwise indicative of the request. In one implementation, the AP creates a table of asset information entries, with one entry allocated for each mobile system within the AP's range. Periodically, the mobile system will power up the wireless NIC to poll the AP to see if any requests are pending. When the mobile system detects the stored asset information request, the mobile system retrieves the requested information, perhaps from an asset information storage device connected directly to the wireless NIC via a system management bus, and forwards the information to the AP. In one embodiment, the AP stores the asset information in the asset information table and transmits the information to the requesting server. Once the asset information, is stored in the AP's asset information table, subsequent asset information requests can be serviced by the AP. In some embodiments, the AP may request and store asset information from the mobile system when the mobile system first associates with the AP so that the asset information is available whenever a server request is made. In other embodiments, the asset information is not stored or otherwise cached on the AP. When any request for the asset information is made, the asset information must be retrieved from the mobile system itself.

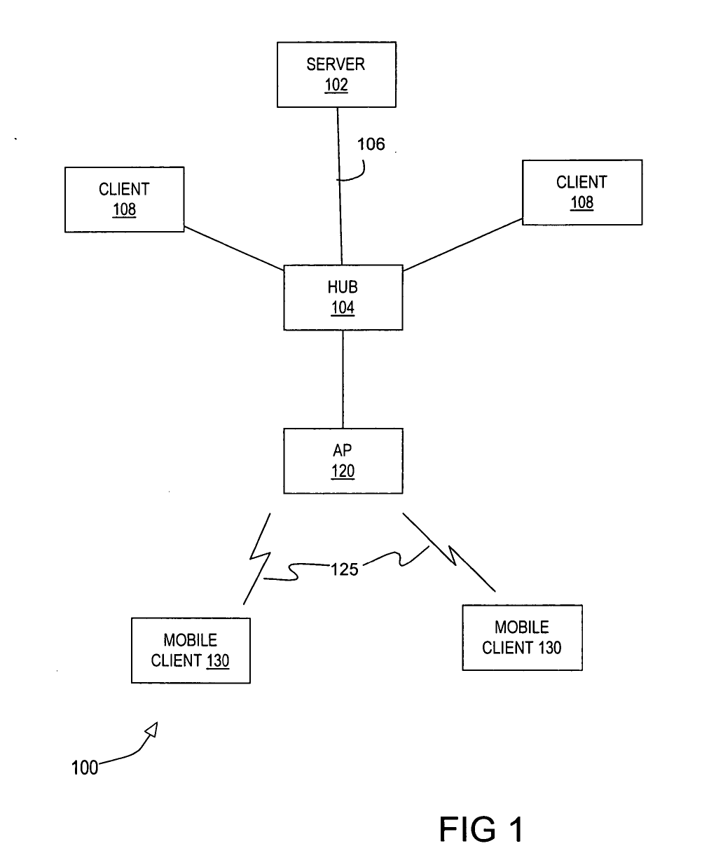

Referring now to the drawings, FIG. 1 is a block diagram of selected elements of a local area network 100 having a wireless AP and a mobile system according to one embodiment of the present invention. In the depicted embodiment, network 100 includes a server 102 connected to a network hub 104 via a network medium 106. Medium 106 is likely an Ethernet compliant medium, but selection of the local area network is an implementation detail and the present invention is intended to cover alternative network implementations.

Network hub 104 is shown as connected to a set of conventional or wired mobile systems 108 and also to a wireless AP 120 via network medium 106. The wireless AP 120 communicates with one or more mobile systems 130 via a wireless protocol represented by reference numeral 125. Wireless protocol 125 is exemplified by an IEEE 802.11b protocol, but other wireless protocols such as Bluetooth may also be used.

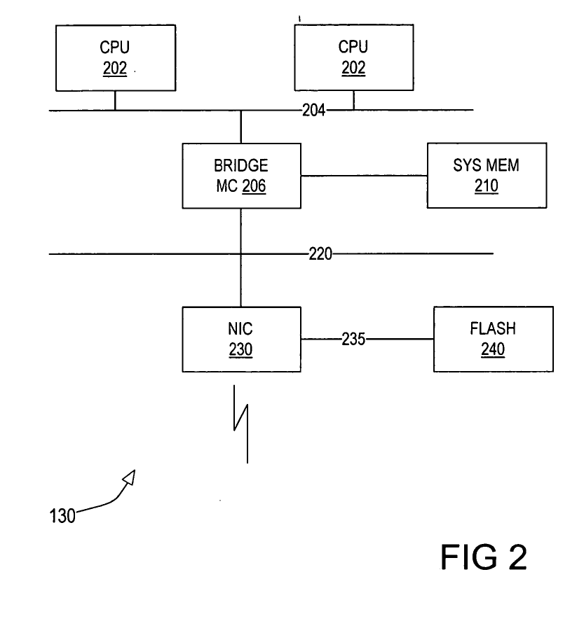

Turning now to FIG. 2, a block diagram of selected elements of the mobile data processing system 130 of FIG. 1 according to one embodiment are depicted. In the depicted embodiment, mobile system 130 includes one or more central processing units (CPU's) 202 connected to a shared system bus 204. A system memory 210 is accessible to CPU's 202 via a bus bridge/memory controller 206. Bridge 206 is connected to a peripheral bus 220, which is exemplified by the Peripheral Component Interface (PCI) bus. A wireless NIC 230 is connected to peripheral bus 220. NIC 230 includes a wireless transceiver for sending/receiving information formatted according to wireless protocol 125 (FIG. 1). An asset information storage unit 240 is connected directly to NIC 230 via a system management (SM) bus 235. Asset information storage unit 240 is preferably a non-volatile storage device that may be implemented with a flash memory card or other form of electrically alterable ROM. Asset information storage unit 240 may be entirely dedicated to the storage of asset information or, in other embodiments, storage unit 240 may contain other data and/or code such as a system BIOS. SM bus 235 is likely implemented as a relatively slow, two wire serial bus that is easy to implement and adequate for low level, system management tasks.

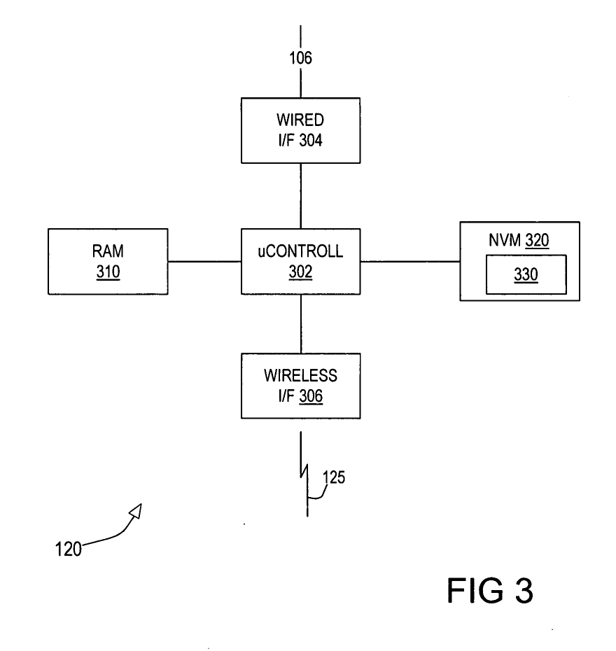

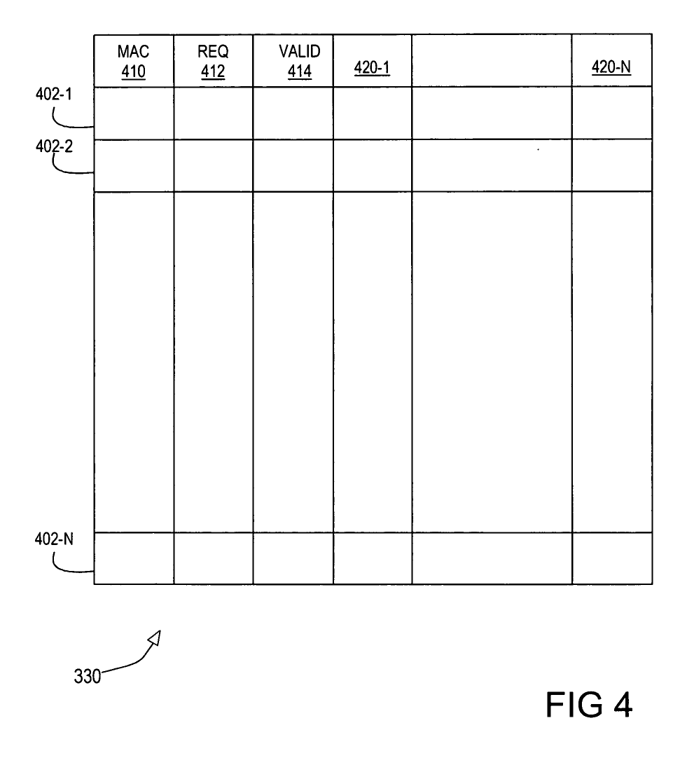

Turning now to FIG. 3, a simplified block diagram of wireless AP 120 of FIG. 1 is depicted. In the depicted embodiment, AP 120 includes a microcontroller connected between a wired interface 304 and a wireless interface 306. Interfaces 304 and 306 include buffering and synchronization circuitry that, under the control of microcontroller 302 enable communication between devices on the wired network medium 106 and devices communicating via the wireless medium 125. Wireless interface 306 and microcontroller 302 are capable of providing distinct wireless connections to multiple devices such as mobile system 130. AP 120 further includes RAM memory 310 and non-volatile memory (NVM) 320 that contains code executable by microcontroller 302. In addition to executable code, the depicted embodiment of NVM 320 includes an asset information table 330 that is used to record pending requests for asset information and, in some embodiments, to store asset information for each mobile system with which AP 120 is associated. As shown in FIG. 4, asset information table 330 is organized as a set of entries 402-1 through 402-N where each entry 402 corresponds to a mobile system that has associated with (e.g., obtained an IP address from) wireless AP 120. In the depicted embodiment, each entry 402 includes a Media Access Control (MAC) address field 410 for storing the MAC address of the corresponding mobile system's wireless NIC and a pending request field 412 of one or more bits to indicate pending request(s) addressed to the corresponding mobile system. In the depicted embodiment of asset information table 330, each entry 402 further includes asset information fields 420-1 through 420-N (collectively referred to as asset information fields 420) for storing the mobile system's asset information. Asset information fields 420, for example, include a serial number field, a manufacturer information field, a model information field, an installation date information field, a warranty information field, etc. Some implementations may elect to use the asset information table 330 as an asset information cache by storing asset information in table 330 when it is retrieved from mobile client 130. In this implementation, any subsequent request for the asset information might be serviced entirely by AP 120. In other implementations it may be desirable for security reasons or otherwise to prevent asset information from being stored on AP 120. In these implementations, asset information table 330 would omit the asset information fields 420.

In some embodiments, portions of the present invention may be implemented as computer executable instructions, stored on a computer readable medium, (i.e., software) for remotely obtaining asset information from a powered down mobile system. All or portions of the software may be stored in nonvolatile storage such as a flash memory device, EEPROM, CD ROM, or hard disk. During execution of the software, all or a portion of the software may be stored in a volatile storage device such as RAM 310 of AP 120. In other embodiments, the invention is a service for enabling a network to support remote acquisition by a server of information stored on a powered down mobile. The software and service embodiments of the invention are best illustrated with respect to a common flow diagram that depicts a method comprised of the steps the software will perform and the steps that the service will enable the system to perform.

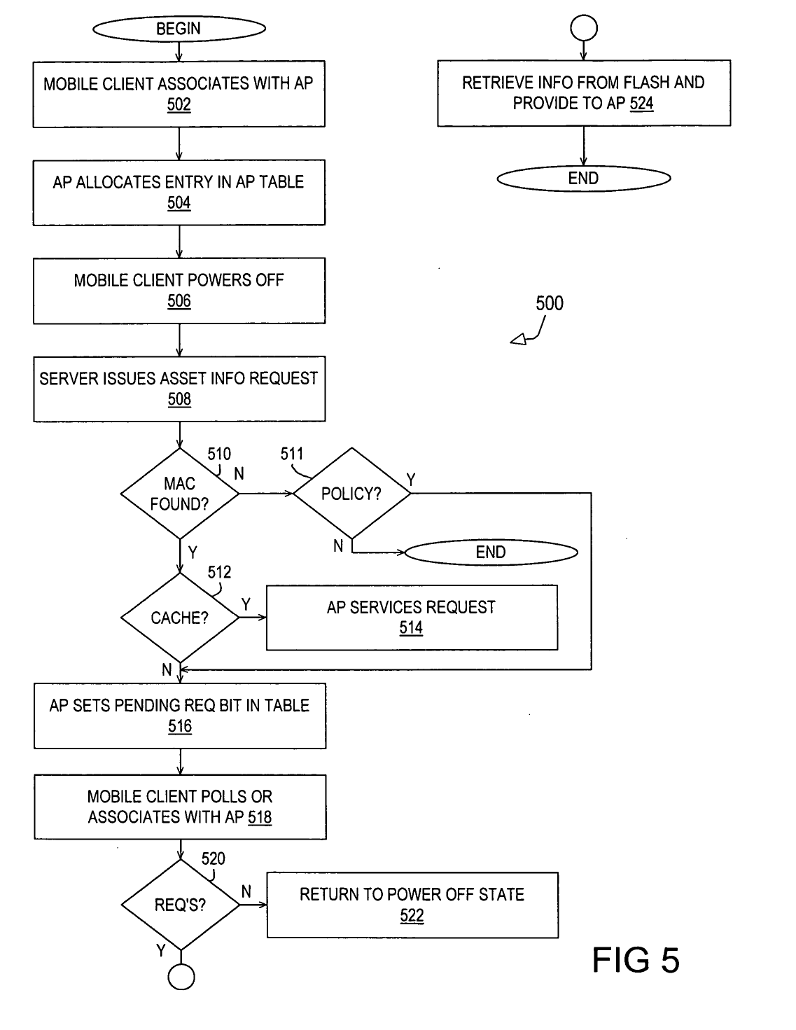

Referring now to FIG. 5, a flow diagram of a method 500 for remote acquisition of asset information from a powered down mobile data processing system according to one embodiment of the invention is presented. In the depicted embodiment, method 500 begins with a mobile system 130 establishing (block 502) an association with an AP 120. This association likely includes, for example, AP 120 assigning an IP address to mobile system 130.

When a mobile system 130 establishes an association with an AP 120, AP 120 allocates (block 504) an entry 402 in asset information table 330 to the new mobile system. In embodiments of network 100 and AP 120 that elect to cache asset information of mobile systems 130 in asset information table 330, AP 120 may issue an asset information request, such as a MIF request, to each mobile system 130 after establishing a connection. In this embodiment, asset information will be present in table 330 in anticipation of a forthcoming asset information request from server 102.

After establishing a connection with AP 120, mobile system 130 may become inactive for a duration sufficient to trigger a power transition (block 506) in mobile system 130 from an operational power state to a sleep state in which substantially all major functional components of mobile system 130 are powered down to conserve battery life. The components that are powered down in this sleep state include the mobile system's wireless NIC 230 thereby rendering the NIC incapable of receiving MIF requests or any other type of network packet from server 102.

At some point after NIC 230 powers down, a deployment or management server exemplified by server 102 issues a request (block 508) to retrieve asset information from mobile system 130. In one embodiment, the asset information request is recognizable as a “magic” packet to which a control field or command extension is appended. The magic packet according to one implementation is a packet with a MAC address repeated 16 times in succession. The magic packet has been used historically as a mechanism to initiate a wake-on LAN (WOL) process. In the present application, a control field appended to the magic packet informs the receiving system that the packet represents a request for asset information.

In response to receiving an asset information request, AP 120 first determines (block 510) whether the system from which information is being requested is “present” (i.e., has associated with AP 120). This determination is made by extracting the MAC address from the magic packet and using the extracted MAC address to index MAC field 410 of asset information table 330. In one embodiment, AP 120 ignores the request if the MAC address in the asset information request is not found in asset information table 330. In another embodiment, AP 120 may, under a predetermined policy, decide (block 511) to either allocate a new entry in asset information table 330 when a request addressed to an “unknown” MAC address is received or to ignore the request. This embodiment might be desirable, for example, when AP 120 has significant spare entries in table 330 or when AP 120 suspects, based on prior usage, that the currently unknown MAC address is likely to associate with AP 120 in the near future.

If the MAC address of the asset information request matches an entry in table 330, the depicted embodiment of method 500 determines (block 512) whether the asset information for the corresponding mobile system is cached (i.e., stored in) AP table 330. Table 330 may include a valid field 414 of one or more bits that indicates whether any information in asset information fields 420 is valid. In an embodiment that prevents asset information from being cached in AP 120, the valid bit fields 414 are pre-set. If there is valid asset information in asset information fields 420 of the appropriate entry 402 in table 330, AP 120 services (block 514) the asset information request directly, without assistance from the mobile system 130.

If the appropriate entry of asset information table 330 does not contain valid asset information in asset information fields 420, AP 120 will use table 330 to record the existence of a pending request for the appropriate mobile system 130. Specifically, AP 120 will set (block 516) one or more bits in the pending request field 412 of the entry 402 corresponding to the MAC address contained in the request. The bit-width of pending request field 412 is implementation specific. A single bit might be sufficient in a simple implementation in which there is only a single server and there is only one type of request that is buffered in the described manner. In other implementations, the pending request field 412 may be wide enough to store the actual request itself so that the identity of the requestor and the type of request are retained. Pending request field 412 may even be configured to store multiple requests.

The dormant wireless NIC 230 on mobile system 130 will, at some point wakeup for the purpose of accessing (block 518) or communicating with AP 120. In one embodiment, MC 230 is configured to periodically wake up and poll AP 120 to determine if there are any requests pending for mobile system 130. In another embodiment, NIC 230 determines if there are any requests pending the next time it associates with AP 120 (e.g., when mobile system 130 is next powered on). In either embodiment, this determination is made by inspecting the pending request field 412 of asset information table 330. If a mobile system 130 determines (block 520) that there is a pending request, mobile system 130 will respond by returning the requested information, the asset information, e.g., to the requesting server. In this manner, asset information is collected by a server remotely from a mobile or wireless mobile system. While the implementation described herein is specific to asset information requests, other server requests may be handled in an analogous manner. Different types of requests, for example, could be handled by appending different control field to the magic packet.

It will be apparent to those skilled in the art having the benefit of this disclosure that the present invention contemplates a mechanism for remote retrieval of information from a mobile client in a network environment. It is understood that the form of the invention shown and described in the detailed description and the drawings are to be taken merely as presently preferred examples. It is intended that the following claims be interpreted broadly to embrace all the variations of the preferred embodiments disclosed.

1. A data processing network configuration, comprising;
an access point configured to receive and store a request to retrieve information from a mobile system associated with the access point;
a mobile system having a wireless network adapter configured to poll the access point to discover the stored request for information on the access point;
wherein the mobile system is configured to respond to discovery of the stored request by retrieving the requested information from nonvolatile storage of the mobile system and transmitting the requested information via the wireless network adapter.

2. The network of claim 1, wherein the access point is configured to recognize the request as a packet containing a media access control (MAC) address repeated multiple times and an appended control field.

3. The network of claim 1, wherein the mobile system is further configured, when in a powered down state, to periodically wake up the wireless network adapter to poll the access point for pending requests.

4. The network of claim 1, wherein the access point is configured to store the pending request in a table having an entry for each mobile system associated with the access point.

5. The network of claim 4, wherein the access point is configured to allocate an entry in the table when a mobile system associates with the access point.

6. The network of claim 5, wherein the access point is further configured to store asset information of the mobile client in the table.

7. A computer program product for remotely retrieving information from a powered-down mobile data processing system, the program product comprising processor executable instructions stored on computer readable media, comprising:
computer code means for storing a server request for asset information from the powered- down mobile system on an access point associated with the powered-down mobile system;
computer code means for querying the access point responsive to subsequently powering the wireless network adapter of the mobile system; and
computer code means, responsive to detecting the stored request for asset information, for retrieving the asset information and forwarding the retrieved information to the access point.

8. The computer program product of claim 7, wherein the code means for retrieving the asset information comprises code means for accessing the asset information from nonvolatile storage on the mobile system while the network adapter is powered on.

9. The computer program product of claim 7, wherein the code means for querying the access point comprise code means for periodically waking the wireless network adapter to poll the access point.

10. The computer program product of claim 7, wherein code means for storing the server request comprises computer code means for storing the request in a table on the access point having an entry for each mobile system associated with the access point.

11. The computer program product of claim 10, wherein each table entry contains a MAC address of the corresponding wireless network adapter.

12. The computer program product of claim 11, wherein the mobile system stores its asset information in the table and further comprising code means, responsive to a subsequent request for the mobile system's asset information, to service using the access point.

13. The computer program product of claim 7, wherein the server request includes the MAC address of the wireless adapter on the mobile system of interest to the server repeated sixteen times and a control field appended thereto.

14. A service for enabling a server to remotely access data from a powered down mobile data processing system, comprising:
enabling the server to transmit a request to retrieve information from a mobile system;
enabling an access point associated with the mobile system to recognize the request and to store information indicative of the request on the access point if the request is addressed to a mobile system associated with the access point;
enabling the mobile client to query the access point for a pending request during a subsequent communication with the access point;
enabling a wireless network adapter of the mobile client, responsive to detecting the stored request for information from the server, to retrieve the requested information and to transmit the requested information to the server through the access point.

15. The service of claim 14, wherein enabling the server to transmit a request includes enabling the server to transmit a packet containing a media access control address of the wireless network adapter repeated multiple times and a control field appended thereto.

16. The service of claim 15, wherein enabling the access point to store information indicative of the request comprises enabling the access point to store information indicative of the request in a table having an entry corresponding to each mobile client associated with the access point, wherein each entry in the request contains the MAC address of the corresponding mobile system's wireless network adapter.

17. The service of claim 16, wherein each entry in the table is further enabled to store the corresponding mobile system's MIF asset information.

18. The service of claim 17, wherein the server request is a request for the mobile client's asset information and wherein the access point services the request itself if the table contains a valid copy of the mobile client's asset information.

19. The service of claim 14, wherein enabling the mobile client to retrieve the information includes enabling the wireless adapter to retrieve data from nonvolatile storage directly connected to the wireless network adapter via a system management bus.

20. The service of claim 14, wherein enabling the mobile client to query the access point comprises periodically waking the wireless network adapter to poll the access point.

21. The service of claim 14, wherein enabling the mobile client to query the access point, comprises enabling the client to query the access point during a subsequent mobile client power on event causing the mobile client to associate with the access point.
